(19) United States
(12) Patent Application Publication
(10) Pub. No.: US 2014/0376166 A1
(43) Pub. Date: Dec. 25, 2014

(54) FRONT MEMBER FOR CAPACITIVE DISPLAY SCREEN PANEL OF ELECTRONIC DEVICES

(71) Applicant: Tamás Kókai, Budapest (HU)

(72) Inventor: Tamás Kókai, Budapest (HU)

(21) Appl. No.: 14/365,458

(22) PCT Filed: Dec. 15, 2011
(86) PCT No.: PCT/HU2011/000126

§ 371 Date: Jun. 27, 2014

(51) Int. Cl. G06F 1/16; G06F 3/044; G06F 3/039

(52) U.S. Cl. CPC G06F 1/1643; G06F 3/039; G06F 3/044
USPC 361/679.3

(57) ABSTRACT

Front member applicable to capacitive display screen (1) panel of electronic devices comprising a fixing element coupled to a screen or to a portion of the casing bordering the screen of the device and a thin, transparent foil-like surface mounted on the fixing element in a given gap distance from the display screen. The foil-like surface (3) is made from a resilient material. When force (F) is applied on a point of the foil-like surface (3) in the direction of the display screen (1) it is able to stretch to form, without permanent deformation, a funnel-shaped elongation (6) within the gap distance (h). The foil-like surface (3) is electrically conductive at least to a certain extent.

The invention relates to a front member applicable to the capacitive display screen panel of electronic devices comprising a fixing element coupled to a screen or to a portion of the casing bordering the screen of the device and a thin, transparent foil-like surface mounted on the fixing element in a given gap distance from the display screen. The display screen panel comprises at least the display screen as well as the driving electronics, the upper protecting sheet, etc.

It is known that operation of the presently used capacitive touch screens is difficult by means of a non-capacitive type device e.g. fingernails. This may cause a problem particularly in case of the relatively small display screen of mobile phones, however the same problem may arise in case of other electronic devices e.g. cameras, video cameras, GPS apparatuses.

In some solutions a special pointer called stylus is used for touching the screen but it can be easily get lost or damaged.

Published patent application US 2009/036176 disclosed an input device especially for user interface purposes in connection with mobile electronic devices. The input device comprises a display device; a capacitive touch sensor overlying the display device; and a pressure-sensing layer underlying or overlying the display device. This layer structure requires, however, a precision alignment between the overlying layers if the sensing and displaying functions desired to be spatially corresponding to each other. Thus the technology is substantially limited to manufacturing and cannot be used as an accessory for existing devices. Furthermore the pressure-sensing layer of a sufficient resolution is quite expensive.

The aim of the present invention is to provide an accessory device by means of which the aforementioned problems can be solved.

The essential idea of the present invention is to place an additional front member before the capacitive display screen panel which elastically stretches when external force exerted by any kind of means is applied on it and due to its conductivity capacitive touch sensing is effectuated. To this it is not necessary to use dedicated means—i.e. a means which is conductive in itself. Precise touch sensing function can be obtained even if a user uses his fingernails.

The front member of the invention according to the preamble is provided with a foil-like resilient surface made from a material which is able to stretch and form—without permanent deformation—a funnel-like shape within the gap distance when force is applied on a point of it in the direction of the display screen and is electrically conductive at least to a certain extent.

The invention will be described with reference to the drawings in which:

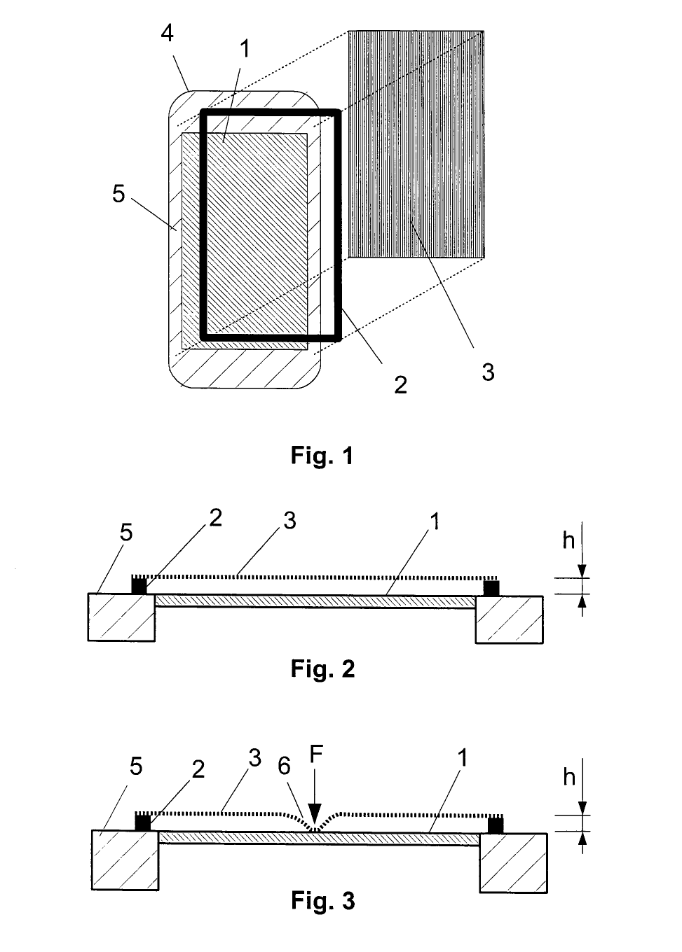

FIG. 1 shows the external front member containing a frame which can be placed on a mobile phone;

FIG. 2 shows the cross-section of the front member in the state of rest according to an embodiment of the invention;

FIG. 3 shows the cross-section of the front member of FIG. 2 when it is activated; and

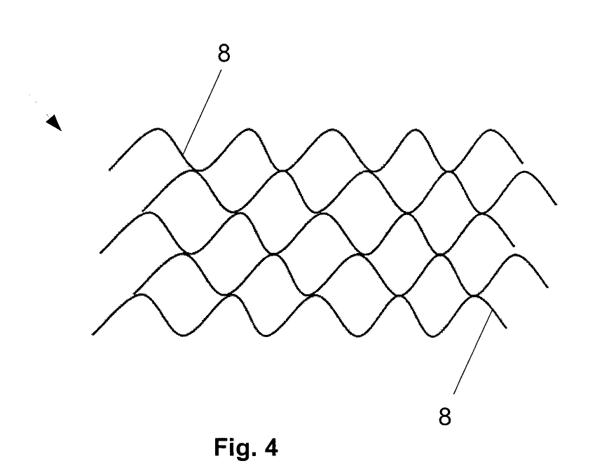

FIG. 4 shows a portion of a further possible embodiment of the front member according to the invention wherein the foil-like surface is formed from a resilient metal mesh.

In the embodiment shown in FIG. 1 the electronic device 4 is a mobile phone having a capacitive display screen 1. The front member according to the invention comprises a frame 2 provided with a foil-like surface 3 tightened on it. Frame 2 entirely encircles the display screen 1 of device 4 when it is placed on it as a front member. Advantageously frame 2 overlaps the edges of display screen 1 on each side. The height of frame 2 determines a distance between the foil-like surface 3 tightened on frame 2 and display screen 1. In this manner a certain gap distance is provided between them. This distance may correspond to the height of frame 2 if display screen 1 of device 4 is level with a portion of the casing 5 encircling it. However, if the latter protrudes above display screen 1 the gap distance will become correspondingly greater.

Frame 2 may be coupled to the portion of casing 5 in several manners known in the art, e.g. by means of suitably profiled snaps, gluing, etc.

The foil-like surface 3 may be implemented in several ways. It may be formed from a transparent resilient plastic material which is made conductible to a certain extent. This can be achieved by applying a thin metal layer subsequently e.g. by metal evaporation or sputtering. In this manner the resilience of the plastic material will not change within limits while the required conductivity thereby capacitive feature is ensured. To this the measure of conductivity and the resultant two-dimensional resistivity should be set at least less than 10 kohms, preferably less than 3 kohms, more preferably less than 0.5 kohms. In an advantageous embodiment the metal layer is applied on the lower side of the foil-like surface 3 i.e. on the side facing the device 4.

The material of the plastic foil may also be made conductive in itself e.g. by mixing some additives in the basic plastic material of the foil during manufacture.

FIG. 2 shows the cross-section of an exemplary embodiment of a front member. The foil-like surface 3 is tightened onto frame 2 and the front member is in the state of rest. In this embodiment the gap distance between the display screen 1 and the foil-like surface 3 essentially corresponds to thickness h of frame 2 fixed to the portion of the casing 5. The thickness h is in a preferable embodiment lies between 1-4 mm. In the Figure the portion of the casing 5 is shown symbolically.

In FIG. 3 the same cross-section can be seen at the moment of activation. The measure of resilience does not need to be significantly great. It must be determined so that when external force F applied to a point of foil-like surface 3 it will not cause permanent deformation, only produces a funnel-shaped elongation 6 in it. Funnel-shaped elongation 6, especially if the foil-like surface is not touched with a sharp tip and so a quasi-flat surface forms in the center of the funnel-shaped elongation, induces the same change in the electromagnetic field and as a result, change of the sensed capacity as if display screen 1 were touched with a finger-tip and this is satisfactory for marking a point.

In certain embodiments frame 2 and the portion of the casing 5 may be formed as an integral unit. In this case device 4 with a casing suitable for this solution may be manufactured. In this possible embodiment the structure is sealed hermetically, and resilience is further facilitated by the air sealed inside as the non-pressed portions will slightly rise resulting in a more contrasted capacity-map in the sensing device.

FIG. 4 shows an enlarged portion of a further embodiment of the front member according to the invention viewed from above. Here a grid-like metal mesh 7 is used as resilient foil-like surface 3 which is woven from thin undulated metal wires 8 so that it is essentially transparent. In this manner reliable touch sensing is ensured similarly to the earlier described foil provided with a conductive layer.

A further possibility is to use a transparent resilient foil to form foil-like surface 3 but the conductive layer is replaced by this metal mesh 7. In this case resilience may be equally ensured by the foil and the metal mesh 7. Advantageously the metal mesh 7 is placed beneath the foil i.e. above the display screen 1. The foil and the metal mesh 7 do not need to be fixed together, it is sufficient if they are fixed to frame 2 individually. In a further possible embodiment a multilayer structure may be used in which the metal mesh 7 is interplaced between two foil layers.

In the description the preferred embodiments of the invention were disclosed, however, various changes and modifications can be made without departing the scope of the invention. For example the plastic material of the foil may be PE, acrylic, vinyl acetate, etc., the structure of the material may be homogeneous, woven, etc. The foil-like surface 3 may also be inhomogenous in respect to stretch or elongation, i.e. its stretch ratio may not be the same all over its surface. A flexible frame itself may also play a role in the elongation. It may also be electrically connected to the electronics of the device that it is attached to.

The advantage of the invention is that capacitive touch screens can reliably sense a touch even if its user uses his fingernails or wears gloves.

1. Front member applicable to capacitive display screen panel of electronic devices comprising a fixing element coupled to a screen or to a portion of the casing bordering the screen of the device and a thin, transparent foil-like surface mounted on the fixing element in a given gap distance from the display screen characterized in that said foil-like surface (3) is made of a resilient material which when force (F) is applied on a point of it in the direction of said display screen (1) is able to stretch to form, without permanent deformation, a funnel-shaped elongation (6) within said gap distance (h), and is electrically conductive at least to a certain extent.

2. Front member according to claim 1 characterized in that said transparent resilient foil-like surface (3) which comprises a plastic foil onto which a metal layer is applied.

3. Front member according to claim 2 characterized in that said metal layer is applied on a side of said foil-like surface (3) facing said display screen (1).

4. Front member according to claim 1 characterized in that the material of said foil-like surface (3) is a homogeneous resilient plastic material which is made conductive in itself.

5. Front member according to claim 1 characterized in that said foil-like surface (3) is a resilient metal mesh (7).

6. Front member according to claim 1 characterized in that the given two-dimensional resistivity is less than 10 kohms.

7. Front member according to claim 1 characterized in that said fixing element is a frame (2) and said foil-like surface (3) is tightened onto it.

8. Front member according to claim 7 characterized in that said frame is coupled mechanically to said portion of the casing (5) bordering said display screen (1) of said device (4) in a detachable manner.

9. Front member according to claim 7 characterized in that said frame (2) and said portion of the casing (5) bordering said display screen (1) of said device (4) is formed as an integral unit.

10. Front member according to claim 1 characterized in that said foil-like surface (3) consists of a foil and a resilient metal mesh (7) placed on each other.
